(19) United States
(12) Patent Application Publication
(10) Pub. No.: US 2024/0054359 A1
(43) Pub. Date: Feb. 15, 2024

(54) Universal self-learning system and self-learning method based on universal self-learning system

(71) Applicant: CENTAURS TECHNOLOGIES CO., LTD., Shenzhen (CN)

(72) Inventor: SHANGFENG HU, Shenzhen (CN)

(21) Appl. No.: 18/231,522

(22) Filed: Aug. 8, 2023

Related U.S. Application Data
(63) Continuation of application No. PCT/CN2022/123880, filed on Oct. 8, 2022.

(30) Foreign Application Priority Data
Aug. 10, 2022 (CN) 202210952851.0

(51) Int. Cl. G06N 5/022; G06N 5/04

(52) U.S. Cl. CPC G06N 5/022; G06N 5/04

(57) ABSTRACT

The present disclosure discloses a self-learning method based on a universal self-learning system. The self-learning method includes: performing inference based on a knowledge in a knowledge base to generate an inference knowledge; performing inference on the basis of acquired nth inference knowledge to obtain (n+1)th inference knowledge, and performing several rounds of inference continuously to form an inference chain; and forming an inference loop if the knowledge inferred according to the inference chain already exists in the inference chain. Through the self-learning method based on the universal self-learning system, the inference loop and an inference cycle about knowledge can be constructed in the knowledge base, and the self-consistency and activity of knowledge in the knowledge base can be maintained through the dynamic and sustainable inference cycle with high activity.

### CROSS-REFERENCE TO RELATED APPLICATIONS

The present application is a U.S. continuation of co-pending International Patent Application No. PCT/CN2022/123880 filed on Oct. 8, 2022, which claims foreign priority of Chinese Patent Application No. 202210952851. 0, filed on Aug. 10, 2022 in the State Intellectual Property Office of China, the contents of all of which are hereby incorporated by reference.

### TECHNICAL FIELD

This application relates to the field of artificial intelligence, and in particular to a universal self-learning system and a self-learning method based on the universal self-learning system.

### BACKGROUND

At present, in the field of artificial intelligence, constructed artificial intelligence systems substantially can only be applied to a certain technical field and can only solve technical problems in a certain technical field. Building a universal artificial intelligence system that can implement independent learning in any field and solve technical problems in multiple technical fields is an urgent technical problem to be solved.

In addition, the present disclosure is an improved solution of the technical solution described in the U.S. Pat. No. 9,639,523B2.

As an embodiment of a parsing graph, a knowledge graph and a probability graph in the present disclosure, the parsing graph may be a word layer, the knowledge graph may be an instance layer and the probability graph may be a class layer or a set layer; as an embodiment of a parsing node, a knowledge node and a probability node in the present disclosure, the parsing node may be a word node, the knowledge node may be an instance node, and the probability node may be a class node or a set node; and for details of the word layer, the instance layer, the set layer, the word node, the instance node and the set node of the embodiment, refer to related contents in U.S. Pat. No. 9,639,523B2. The related contents disclosed in the previous patent are not described in detail in the present disclosure, but are briefly mentioned and explained, so that the present disclosure can be read completely without the previous patent.

### SUMMARY

The present disclosure provides a universal self-learning system and a self-learning method based on the universal self-learning system, so as to solve the technical problems in related art.

A self-learning method based on a universal self-learning system is provided, the universal self-learning system including a knowledge base and an inference engine, the knowledge base including several knowledges, the self-learning method including the following steps: performing inference, by the inference engine on the basis of the knowledge in the knowledge base to generate an inference knowledge, performing inference on the basis of acquired nth inference knowledge to acquire (n+1)th inference knowledge, and performing several rounds of inference continuously to form an inference chain; and forming an inference loop if the knowledge inferred according to the inference chain already exists in the inference chain.

Optionally, a self-learning method based on a universal self-learning system is provided, the universal self-learning system further including a judging machine, the judging machine being configured to check knowledges in the knowledge base and to find and process the knowledges having contradiction, the self-learning method including the following steps: checking a generated (n+1)th inference knowledge based on the existing knowledge in the knowledge base; if the (n+1)th inference knowledge does not have contradiction with the existing knowledge in the original knowledge base, continuing inference on the basis of the (n+1)th inference knowledge; if the (n+1)th inference knowledge has contradiction with the existing knowledge in the original knowledge base and wrong knowledge or a knowledge with a lower accuracy in the knowledges having contradiction is the knowledge in the (n+1)th inference knowledge, causing an interruption of an inference process.

Optionally, a self-learning method based on a universal self-learning system is provided, including the following steps: under the condition that new knowledge not existing in the original knowledge base is inputted into the original knowledge base, starting inference based on the new knowledge not existing in the original knowledge base; under the condition that interruption of an inference process does not occur after a preset time, inputting the new knowledge that does not exist in the knowledge base into the knowledge base to start new inference and continuous inference; and under the condition that interruption of the inference process occurs, excluding newly inputted new knowledge not existing in the original knowledge base and additionally inputting new knowledge not existing in the original knowledge base to perform inference.

Optionally, a self-learning method based on a universal self-learning system is provided, the inference loop is a dynamic structure; under the condition that the knowledge outside the inference loop does not interfere with the inference loop, the inference loop is in a stable state; under the condition that the knowledge outside the inference loop is capable of being integrated into the inference loop, a new inference loop including the existing knowledge in the original inference loop and the newly integrated knowledge is formed, and the inference loop becomes larger, under the condition that the knowledge outside the inference loop and some knowledge in the original inference loop form a new inference loop, a state change of the inference loop is pending; and under the condition that the knowledge outside the inference loop allows the inference loop to be unable to continue to connect, the inference loop changes from a loop structure to an inference chain structure.

Optionally, a self-learning method based on a universal self-learning system is provided, wherein the inference loop includes a plurality of nodes, and the nodes have connection relations to form the loop structure and the nodes are capable of being activated; and when the inference engine performs circular inference on a connection path of the inference loop, the nodes on the inference loop are activated periodically, and a dynamic cycle in which the nodes on the inference loop are activated constitutes an inference cycle.

Optionally, a self-learning method based on a universal self-learning system is provided, wherein the nodes have state values, node state value change situations and corresponding node state value change values are preset, the preset node state value change situations including: every time the nodes are activated, the state values of the nodes increase; every time after a preset duration is elapsed, the state values of the nodes decrease; and the state values of the nodes can be reduced cumulatively until a preset minimum value is reached.

Optionally, a self-learning method based on a universal self-learning system is provided, wherein under the action of the inference cycle, a state value of the inference loop has one of three numerical states, namely, a stable unchanging state, a stable increasing state and a stable decreasing state.

Optionally, a self-learning method based on a universal self-learning system is provided, wherein when the node is activated, an activated state propagates from the node in the activated state to other nodes on the connection path along the connection path of the nodes, so that the other nodes are activated, thereby increasing the state value of the node connection path.

Optionally, a self-learning method based on a universal self-learning system is provided, wherein an incidence relation exists between the node state value and a node use priority, and the greater the node state value is, the higher the node use priority is.

Optionally, a self-learning method based on a universal self-learning system is provided, wherein an inference engine is generated based on the knowledge in the knowledge base.

Optionally, a self-learning method based on a universal self-learning system is provided, wherein the construction of inference engine includes the following steps: summarizing knowledge generation probability rules in the knowledge base; and based on the probability rules, performing inference on the basis of the knowledge in the knowledge base to generate the inference knowledge.

Optionally, a self-learning method based on a universal self-learning system is provided, wherein the construction of the judging machine includes the following steps: checking a knowledge to be checked based on the existing knowledge in the knowledge base, and judging a relation between the knowledge to be checked and the existing knowledge in the original knowledge base; under the condition that the existing knowledge having contradiction with the knowledge to be checked is found, checking correctness of the knowledge to be checked and the existing knowledge having contradiction with the knowledge to be checked; and based on a checking result, excluding wrong knowledge or a knowledge with a lower accuracy from the knowledge base.

An electronic device including a processor and a memory, the processor being configured to read and execute the execution in the memory, so as to implement the self-learning method based on the universal self-learning system.

A computer-readable storage medium having stored thereon a computer program and/or a knowledge base, the computer program, when executed by a computer, implementing the self-learning method based on the universal self-learning system.

Compared with the prior art, the technical solution provided by the present disclosure has the following advantages: through the self-learning method based on the universal self-learning system, the inference loop and the inference cycle about knowledge can be constructed in the knowledge base, and the self-consistency and activity of knowledge in the knowledge base can be maintained through the dynamic and sustainable inference cycle with high activity. Based on several inference cycles, independent learning in any field can be realized and the technical problems in multiple technical fields can be solved.

### BRIEF DESCRIPTION OF DRAWINGS

FIG. 1 is a parsing graph of a statement “Xiaoming will walk to a canteen”.

FIG. 2 is a schematic diagram of transformation from the parsing graph to a knowledge graph.

### DETAILED DESCRIPTION

In order to make the purposes, technical solutions and advantages of the embodiments of the present disclosure clearer, the technical solutions in the embodiments of the present disclosure will be described clearly and completely below in conjunction with accompanying drawings. Apparently, the embodiments described are some embodiments of the present disclosure, but not all of embodiments. All of the other embodiments, obtained by those of ordinary skill in the art based on the embodiments of the present disclosure without any inventive efforts, fall into the protection scope of the present disclosure.

In order to facilitate the understanding of the embodiments of the present disclosure, the specific embodiments will be further explained with reference to the attached drawings, and the embodiments do not constitute the limitations of the embodiments of the present disclosure.

It should be noted that the relation terms, such as “first” and “second”, are used herein only for distinguishing one entity or operation from another entity or operation but do not necessarily require or imply that there exists any such actual relation or sequence between these entities or operations. Also, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. In the case of no more limitations, the element limited by the statement “comprising ⋅ ⋅ ⋅ ” does not exclude that there exists another same element in the process, method, article or device comprising the element.

A universal self-learning system is configured to implement self-learning about knowledge, and includes a knowledge base, an inference engine and a judging machine, wherein the knowledge base is configured to store knowledge. The inference engine is configured to preform inference on the basis of the knowledge in knowledge base to generate an inference knowledge. The judging machine is configured to check the knowledges in the knowledge base and to find and process the knowledges having contradiction.

The knowledge in the knowledge base includes existing knowledge in the original knowledge base and knowledge newly inputted into the knowledge base. The original knowledge base is a knowledge base to which knowledge has not been newly inputted.

A relation between the knowledge newly inputted into the knowledge base and the existing knowledge in the original knowledge base includes the following situations: the knowledge newly inputted into the knowledge base already exists in the original knowledge base, the knowledge newly inputted into the new input knowledge base does not exist in the original knowledge base, further the knowledge newly inputted into the knowledge base has contradiction with the existing knowledge in the original knowledge base.

The inference knowledge includes new knowledge not existing in the original knowledge base and existing knowledge that exists in the original knowledge base. The original knowledge base is the knowledge base before the inference knowledge is generated.

Further, the inference engine may be generated based on the knowledge in the knowledge base.

A method for constructing a universal self-learning system includes constructing a knowledge base, constructing an inference engine and constructing a checking machine. There are many ways to construct the knowledge base, the inference engine and the checking machine, such as, to construct based on an expert system, to construct based on machine learning, to construct based on a neural network, and there are constructing ways in which various technical paths that are matched and mixed. In order to facilitate the understanding of the present disclosure to have a deeper and more vivid understanding of the present disclosure, a specific embodiment is provided to describe a method for constructing a universal self-learning system in detail. This specific embodiment is only used to help understand the technical concept of the present disclosure, and it is used to show that the technical concept of the present disclosure is supported by a technical solution of a specific implementation, and this specific embodiment does not constitute a limitation on the concept of the present disclosure.

An embodiment is now provided to describe the construction of the knowledge base in detail.

In this embodiment, the knowledge in the knowledge base is stored in the form of knowledge graphs, and the knowledge base includes several knowledge graphs. The generation of the knowledge graph includes the following steps.

S11, giving a standard training set, the standard training set including several standard statements.

Preferably, the standard training set includes several standard training texts, the standard training texts include several standard statements, and an incidence relation exists between a part of standard statements in a same standard training text.

S12, presetting a parsing model to parse the standard statements into several parsing graphs.

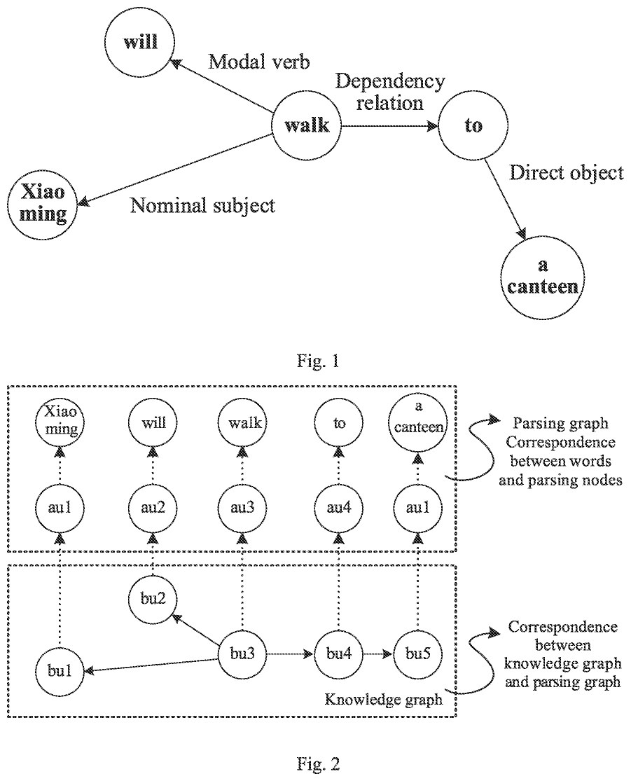

With reference to FIG. 1, FIG. 1 shows a parsing graph of a statement “Xiaoming will walk to a canteen”.

The parsing graph includes parsing nodes and parsing node relation lines, and if an incidence relation exists between two parsing nodes, the parsing node relation line connects the two parsing nodes. The incidence relation includes a semantic relation, a grammatical relation and other types of incidence relations, and the parsing node is a phrase.

S13, transforming the parsing graph into the knowledge graph according to preset rules.

With reference to FIG. 2, FIG. 2 is a schematic diagram of transformation from the parsing graph into the knowledge graph.

The knowledge graph includes knowledge nodes and knowledge node relation lines, and if an incidence relation exists between two knowledge nodes, the knowledge node relation line connects the two knowledge nodes. The knowledge node is a phrase set including several words with common attributes, such as fruits including watermelon, orange and apple.

The transformation of the parsing graph into the knowledge graph includes the transformation of the parsing nodes into the knowledge nodes and the transformation of the parsing node relation lines into the knowledge node relation lines. The parsing node is transformed into the knowledge node, that is, words are transformed into a phrase set. The attributes of words, the corresponding relation between the words and the phrase sets as well as other information of the words can be obtained based on dictionaries or lexicons, that is, the transformation from the parsing nodes to the knowledge nodes can be completed based on the dictionaries or lexicons. If the incidence relation represented by the parsing node relation line is the same as the incidence relation represented by the knowledge node relation line, the transformation from the parsing node relation line to the knowledge node relation line can be completed, and there is a corresponding and reference relation between the knowledge node and the corresponding parsing node.

An embodiment is now provided to describe the construction of the inference engine in detail.

In this embodiment, the inference engine includes probability rules, and the inference engine can perform inference based on the probability rules. The construction of inference engine includes the following steps.

S21, acquiring matching situations among several knowledges.

Specifically, if a knowledge graph only includes two knowledge nodes and a knowledge node relation line connecting the two knowledge nodes, the knowledge graph is a basic sub-graph of the knowledge graph, which is called a knowledge triple. It can be appreciated that any knowledge graph is formed by connecting one basic sub-graph (knowledge triple) or several basic sub-graphs (knowledge triples).

If knowledge nodes of a first knowledge triple and knowledge nodes of a second knowledge triple have a co-reference relation, it is considered that the knowledge nodes of the first knowledge triple are mutually matched with knowledge nodes of the second knowledge triple. The co-reference relation refers to the referential relation between referents with the same or equivalent meanings, including synonymy, near-synonymy, a whole and part relation, a superordinate concept and a subordinate concept and other similar relations; it can be considered that phrases with the co-reference relation only have different forms and are identical or equivalent in essence, such as a cellphone and a mobile phone.

If the knowledge node relation line of the first knowledge triple and the knowledge node relation line of the second knowledge triple include the same relation type and the same direction of the relation type, it is considered that the knowledge node relation line of the first knowledge triple is mutually matched with the knowledge node relation line of the second knowledge triple.

If three elements of the first knowledge triple are mutually matched with three elements of the second knowledge triple, it is considered that the first knowledge triple and the second knowledge triple are matched with each other.

S22, connecting two knowledges if the two knowledges have contents that can be mutually matched.

Specifically, if knowledge nodes that can be mutually matched exist between two knowledge graphs, the two knowledge graphs are connected based on the mutually matched knowledge nodes. For example, if there are knowledge nodes in the first knowledge graph that are mutually matched with the knowledge nodes in the second knowledge graph, the knowledge nodes that are mutually matched can be connected or merged to connect the first knowledge graph and the second knowledge graph, so as to form a third knowledge graph including the first knowledge graph and the second knowledge graph.

Through steps S21 and S22, scattered and fragmented knowledge can be sorted into structured knowledge to strengthen the understanding of the knowledge. A process of matching and connecting the knowledge in the knowledge base can be compared with a process of consolidating and learning existing knowledge, constructing a connection between knowledges and deepening the understanding of the knowledge by a human brain. For example, if there exists a mathematical knowledge and a mathematical problem, the mathematical problem can be solved based on this mathematical knowledge. If we know the mathematical knowledge, but we do not know how to solve a mathematical problem when we see it, it is because we have not connected the mathematical knowledge with the mathematical problem, and at this time, the mathematical knowledge and the mathematical problem are two separated and fragmented knowledges in our minds; if we find contents that can be matched with each other between the mathematical knowledge and the mathematical problem and solve the mathematical problem according to the matched contents and the mathematical knowledge, we build a connection between the mathematical knowledge and the mathematical problem and the structured knowledge is formed.

S23, summarizing knowledge generation probability rules in the knowledge base.

In this embodiment, the probability rules are represented and stored in the form of probability graphs, and the probability rules include several probability graphs. The probability graph includes probability nodes and probability node relation lines; if an incidence relation exists between two probability nodes, the probability node relation line connects the two probability nodes; there is a connection probability between the two probability nodes; and the connection probability is marked on the probability node relation line. The probability node is a summary of several knowledge nodes, and is a set of several knowledge nodes.

The probability graph includes a basic graph and an extended graph which have a one-to-one correspondence. The generation of the probability graph includes the following steps.

S231, generating a basic graph.

Given a certain knowledge triple x, all the knowledge triples that are matched with the knowledge triple x are found in the knowledge base to constitute a knowledge triple set X, and the knowledge triple set X is summarized to generate the basic graph.

Specifically, the knowledge triple set X includes a knowledge node set Xa, a knowledge node set Xb and a knowledge node relation line set, one probability node ja of the basic graph is a summary of the knowledge node set Xa, another probability node jb of the basic graph is a summary of the knowledge node set Xb, and the probability node relation line of the basic graph is a summary of the knowledge node relation line set.

S232, generating an extended graph.

All the knowledge node sets Ya and Yb having a connection relation with the knowledge triple set X are found in the knowledge base. Where, the knowledge node set Ya is connected with the knowledge node set Xa in the knowledge triple set X, and the knowledge node set Ya is not matched with the knowledge node set Xb in the knowledge triple set X; the knowledge node set Yb is connected with the knowledge node set Xb in the knowledge triple set X, and the knowledge node set Yb is not matched with the knowledge node set Xa in the knowledge triple set X.

The knowledge node sets Ya and Yb are summarized to generate the extended graph.

According to the type of the knowledge node relation line connected with the knowledge node set Xa, the knowledge nodes in the knowledge node set Ya are subjected to primary classification; on the basis of the primary classification, the knowledge nodes are subjected to secondary classification according to matching situations between the knowledge nodes; and knowledge node subsets in the knowledge node set Ya are obtained. If there are n knowledge nodes in the knowledge node set Ya and p knowledge nodes in a certain knowledge node subset, p≤n, then the connection probability between the knowledge node subset and the knowledge node set Xa is p/n. The knowledge node subset is summarized as a probability node ta in the extended graph, then the connection probability between the probability node ta and the probability node ja in the basic graph is p/n.

Through the above steps, all probability nodes in the extended graph and the connection probability between each probability node and the basic graph are obtained. There is a one-to-one correspondence between the extended graph and the basic graph.

If the connection probability p/n of the probability node and the basic graph is 100%, it is considered that the probability node and the basic graph are necessarily connected.

If the connection probability p/n of the probability node and the basic graph is less than 100%, it is considered that the probability node is possibly connected with the basic graph have a connection possibility.

S233, connecting the extended graph to the corresponding basic graph to form a probability graph.

In order to facilitate explanation and understanding and more clearly define generation processes, relations and meanings of the basic graph and the extended graph, in the aforementioned example, the basic graph only includes one probability triple, and the extended graph only includes several probability nodes and probability node relation lines connecting the basic graph with the probability nodes.

It can be appreciated that the basic graph can also include several probability triples having connection relations, and the extended graph can also include several sub-graphs that can be connected with the basic graph. In this case, the basic graph can be understood as a condition, the extended graph can be understood as a result. A relation between the basic graph and the extended graph can be understood as follows: if this condition of the basic graph is met, this result of the extended graph can be obtained; and the sub-graphs included in the extended graph are possible sub-results after the condition of the basic graph is met, and each sub-result has a corresponding obtaining probability. In order to facilitate the understanding of this paragraph, a hypothetical simplified example is now provided to illustrate this paragraph. For example, the basic graph (condition) is “having eaten spoiled food”, and the extended graph (result) or a sub-graph in the extended graph is “diarrhea”.

S24, based on the probability rules, performing inference on the basis of the knowledge in the knowledge base to generate the inference knowledge.

Given a knowledge graph f if there is a basic graph that can be matched with the knowledge graph f, the extended graph is connected to the knowledge graph f, and the extended graph connected to the knowledge graph f is the inference knowledge generated by the knowledge graph f through inference under the action of probability rules.

If the connection probability of the sub-graph or the probability node in the extended graph is 100%, then it is considered that knowledge connected to the knowledge graph based on the sub-graph or the probability node is correct knowledge, and this process can be compared with a reasonning process of the human brain.

If the connection probability of the sub-graph or the probability node in the extended graph is less than 100%, then knowledge connected to the knowledge graph based on the sub-graph or the probability node may be correct knowledge or wrong knowledge, and this process can be compared with a guess process of the human brain. It can be appreciated that the closer the connection probability of the sub-graph or the probability node in the extended graph is to 100%, the higher the possibility that the knowledge connected to the knowledge graph based on the sub-graph or the probability node is correct knowledge is.

Further, a connection probability threshold can be set such that only the sub-graph or the probability node with the connection probability greater than the connection probability threshold is connected to the knowledge graph. By adjusting the connection probability threshold, the amount and accuracy of the obtained inference knowledge can be adjusted.

Through step S24, the universal self-learning system can perform inference to continuously obtain an inference knowledge according to the existing knowledge in the knowledge base without external knowledge being inputted, and consolidate the existing knowledge or obtain new knowledge to implement the consolidation and update of the knowledge in the knowledge base. This process can be regarded as a process in which human beings repeatedly learn the existing knowledge, review old knowledge through reasonning or imagination, and draw inferences about other cases from one instance.

In order to facilitate the understanding of S23 and S24, a hypothetical simplified example is provided. In this example, both the knowledge graph and the probability graph are subjected to hypothesis and simplification processing. This example is only used for simple illustration, as shown in FIG. 2.

In the knowledge base of S23, there are a first knowledge graph “Xiaoming walks to a canteen”, a second knowledge graph “Xiaoming walks to a bathhouse”, a third knowledge graph “Xiaohua walks to a dining room”, a fourth knowledge graph “Tang Monk walks to the Western Heaven” and a fifth knowledge graph “Xiaoming walks”.

Given a knowledge triple “Xiaoming walks”, a first knowledge node is “Xiaoming”, a first knowledge node “walks” and a knowledge node relation line is “nominal subject”.

All the knowledge triples “Xiaoming walks”, “Xiaohua walks” and “Tang Monk walks” that are matched with the knowledge triple “Xiaoming walks” are found in the knowledge base and form a knowledge triple set, and the knowledge triple set is summarized to generate a basic graph “a human walks”.

All the knowledge node sets having a connection relation with the knowledge triple set, such as “to a canteen”, “to a bathhouse”, “to a dining room” and “to the Western Heaven”, are found in the knowledge base. The connection probability of a subset “to a canteen, to a dining room” is 0.5, the connection probability of a subset “to a bathhouse” is 0.25, and the connection probability of a subset “to the Western Heaven” is 0.25. The extended graph {“to a canteen, to a dining room” 0.5; “to a bathhouse” 0.25; “to the Western Heaven” 0.25} is generated.

The fifth knowledge graph “Xiaoming walks” in S24 has a basic graph “a human walks” matched therewith, and the extended graph is connected to the fifth knowledge graph “Xiaoming walks” to obtain inference knowledges, namely, “Xiaoming walks to a canteen”, “Xiaoming walks to a dining room”, “Xiaoming walks to a bathhouse” and “Xiaoming walks to the Western Heaven”. Among them, “Xiaoming walks to a canteen” and “Xiaoming walks to a bathhouse” are generated existing knowledge; “Xiaoming walks to a dining room” and “Xiaoming walks to the Western Heaven” are generated new knowledge. Among them, “Xiaoming walks to a canteen”, “Xiaoming walks to a bathhouse” and “Xiaoming walks to a dining room” are correct knowledges, and “Xiaoming walks to the Western Heaven” is wrong knowledge.

It can be appreciated that when the inference knowledge is generated based on the inference according to the probability rules, the inference can be inference according to one sentence, one knowledge, or a group of knowledge. One knowledge may include several sentences; and a group of knowledge may include several knowledges.

It can be appreciated that when the inference knowledge is generated based on the inference according to the probability rules, a bifurcation state of the inference knowledge can be formed. For example, the inference knowledge generated by one sentence can be several sentences; the inference knowledge generated by one knowledge can be several knowledges; and inference knowledge generated by a group of knowledge can be several groups of knowledges. In this embodiment, the inference is performed based on one group of knowledges, and several groups of inference knowledges are acquired.

It can be appreciated that assuming that one group of knowledges has a defined range, in an inference process, the inference is performed based on one group of knowledges in the defined range, and in the inference process, there may be other knowledge outside the defined range or other related knowledge to participate in the inference process to assist in the inference.

An embodiment is now provided to describe the construction of the judging machine in detail.

Let the knowledge to be checked be a first knowledge, the first knowledge including existing knowledges in the knowledge base, inference knowledges obtained by inference and knowledges newly inputted into the knowledge base. The first knowledge may be new knowledge not existing in the knowledge base originally, or may be existing knowledge that already exists in the knowledge base originally.

S31, checking the first knowledge based on the existing knowledge in the knowledge base, and judging a relation between the first knowledge and the existing knowledge in the original knowledge base.

Checking the first knowledge based on the existing knowledge in the knowledge base includes the following checking results: the first knowledge is the existing knowledge in the original knowledge base; the first knowledge is new knowledge not existing in the original knowledge base; further the first knowledge has contradiction with the existing knowledge in the knowledge base.

In order to facilitate the understanding of the checking results, a hypothetical simplified example is provided. In this example, the knowledge is subjected to hypothesis and simplification processing. This example is only used for simple illustration. Let the first knowledge be “the sun is golden”, and if there is “the sun is golden” in the existing knowledge in the original knowledge base, then the first knowledge is the existing knowledge in the original knowledge base; if the existing knowledge in the original knowledge base does not have a color attribute of the sun, that is, the color of the sun is unknown according to the existing knowledge in the original knowledge base, at this time, the first knowledge is new knowledge not existing in the original knowledge base; and if there is “the sun is white” in the existing knowledge in the original knowledge base, at this time, the first knowledge has contradiction with the existing knowledge in the knowledge base.

If the first knowledge has contradiction with the existing knowledge in the knowledge base, the correctness of the first knowledge and the existing knowledges having contradiction with the first knowledge is also checked to obtain correct knowledge or a knowledge with a higher accuracy, so as to continuously deepen correct understanding of the knowledge.

Specifically, checking the first knowledge based on the existing knowledge in the knowledge base may include the following methods.
(1) Checking a given knowledge graph based on a matching method of a knowledge graph in a knowledge base.

Given a first knowledge graph, if there is a second knowledge graph in the knowledge base that can be completely matched with the first knowledge graph successfully, then it is considered that the universal self-learning system can fully understand the given first knowledge graph, the first knowledge graph being existing knowledge in the original knowledge base.
(2) Checking the given knowledge graph based on probability rules.

Given a first knowledge graph, all basic graphs that can be matched with a knowledge triple of the knowledge graph are found in the probability rules; and

if there is a knowledge triple x in the knowledge graph and there is no basic graph matched with the knowledge triple in the probability rules, then it is considered that the knowledge triple x cannot be understood because of the lack of corresponding knowledge in the universal self-learning system.

If there is a knowledge triple x in the first knowledge graph that can be matched with the basic graph, the knowledge triple y connected to the knowledge triple x is compared with the extended graph connected to the basic graph; and
if there is a knowledge triple y in the first knowledge graph and there is no extended graph matched with the knowledge triple y, then the knowledge triple y cannot be understood because of the lack of corresponding knowledge in the universal self-learning system.

If there is a probability graph in the probability rules that can be matched with all the knowledge triples of the knowledge graph, and a connection mode is exactly the same, it is considered that the knowledge graph can be completely understood based on the probability rules.

The reasons for the lack of corresponding knowledge in the universal self-learning system include: 1. the knowledge triple in the first knowledge graph is correct, but there is no relevant knowledge in the universal self-learning system, and at this time, the first knowledge graph is new knowledge not existing in the original knowledge base; 2. the knowledge triple in the knowledge graph is wrong and has contradiction with the existing knowledge, for example, a human has four legs.

It can be appreciated that the two knowledge checking methods above can be used alternatively or used at the same time. In addition, there are various knowledge checking methods, and the knowledge checking method described in this embodiment is only one of the various knowledge checking methods, and only used for illustrative explanation and does not constitute a limitation to the present disclosure.

S32, checking the first knowledge based on the existing knowledge in the knowledge base and finding the existing knowledges having contradiction with the first knowledge, the checking the correctness of the first knowledge and the existing knowledges having contradiction with the first knowledge including the following steps.

Optionally, it includes S321, processing knowledges having contradiction based on a knowledge source.

If the first knowledge graph has contradiction with the second knowledge graph, the first knowledge graph is generated based on the standard training set, and the second knowledge graph is generated by inference based on the probability rules, it is considered that the first knowledge graph is correct knowledge. If both the first knowledge graph and the second knowledge graph are generated by inference based on the probability rules, processing is performed in S322.

S322, processing knowledges having contradiction based on the probability rules.

If the first knowledge graph has contradiction with the second knowledge graph, the generation probabilities of the first knowledge graph and the second knowledge graph are compared, and if there is a difference between generation probability values, it can be considered that the knowledge graph with a larger generation probability value is correct knowledge or a knowledge with a higher accuracy. There is contradiction between the first knowledge graph and the second knowledge graph includes there is contradiction between the first knowledge graph and the second knowledge graph as a whole, or there is contradiction between sub-graphs in the first knowledge graph and the second knowledge graph.

Specifically, connection probability values corresponding to the contradictory graphs in the first knowledge graph and the second knowledge graph in the probability rules are compared; if there is a difference between the connection probability values, it can be considered that the knowledge graph corresponding to the graph with a larger connection probability value is correct knowledge or a knowledge with a higher accuracy.

Optionally, it also includes setting a connection probability value difference threshold, and if a difference of a connection probability value corresponding to the contradictory graphs in the first knowledge graph and the second knowledge graph in the probability rules exceeds the preset connection probability value difference threshold, it is considered that the knowledge graph corresponding to the graph with a larger connection probability value is correct knowledge or a knowledge with a higher accuracy.

Optionally, it also includes S323, processing knowledges having contradiction based on external supervision.

If the first knowledge graph has contradiction with the second knowledge graph, and both the first knowledge graph and the second knowledge graph are generated based on the standard training set, an error can be reported and submitted to an external supervisor, and correct knowledge is determined through external supervision and intervention.

If a difference between the connection probability values corresponding to the contradictory graphs in the first knowledge graph and the second knowledge graph in the probability rules is within the preset connection probability value difference threshold, an error can be reported and submitted to the external supervisor, and correct knowledge can be determined through external supervision and intervention.

It can be appreciated that the method of processing knowledges having contradiction based on the knowledge source, the method of processing knowledges having contradiction based on the probability rules and the method of processing knowledges having contradiction based on the external supervision can also be parallel, and there is no sequential order of application of the methods, or the sequential order of the application of the three methods is not consistent with that of the above embodiment.

S33, based on a checking result, excluding wrong knowledge or a knowledge with a lower accuracy from the knowledge base.

A self-learning method based on a universal self-learning system includes the following steps.

S41, performing inference on the basis of the knowledge in the knowledge base to generate the inference knowledge.

In one embodiment, whenever new knowledge not existing in the original knowledge base is inputted into the knowledge base, inference is started based on the new knowledge not existing in the original knowledge base, and inference is performed based on the inputted new knowledge not existing in the original knowledge base to generate an inference knowledge.

Here, “inference is performed based on the inputted new knowledge not existing in the original knowledge base” means that the inputted new knowledge not existing in the original knowledge base is indispensable knowledge in the inference process, and there may be other existing knowledge in the knowledge base that participates in the inference process.

It can be appreciated that new knowledge not existing in the original knowledge base, after being inputted into the knowledge base, is knowledge in the knowledge base.

S42, performing (n+1)th inference on the basis of acquired nth inference knowledge to obtain (n+1)th inference knowledge, and performing several rounds of inference to form an inference chain. Where, n≥0, the inference chain is formed by connecting several knowledges with an inference relation sequentially according to the inference relation.

It can be appreciated that when n=0, “performing inference on the basis of acquired nth inference knowledge to obtain (n+1)th inference knowledge” means “performing inference based on the knowledge in the knowledge base to generate an inference knowledge”.

In one embodiment, “performing (n+1)th inference on the basis of acquired nth inference knowledge” means that the nth inference knowledge is indispensable knowledge in the (n+1)th inference, but when the (n+1)th inference is performed, other knowledge except the nth inference knowledge may also participate in the (n+1)th inference. That is, it is possible that the (n+1)th inference knowledge is inferred by combining the nth inference knowledge and other knowledge except the nth inference knowledge in the knowledge base. It can be appreciated that in this case, if there is a lack of other knowledge except the nth inference knowledge in the knowledge base, the (n+1)th inference knowledge cannot be obtained only based on the nth inference knowledge. Usually, other knowledge except the nth inference knowledge that participates in the (n+1)th inference is related to the nth inference knowledge.

It can be appreciated that after the inference is started, the inference will be performed continuously based on an inference result under the action of the inference engine until an abnormal situation occurs or a target result is reached.

Optionally, after the (n+1)th inference knowledge is generated according to S41 and S42, it further includes S43, checking a generated (n+1)th inference knowledge based on the existing knowledge in the knowledge base.

If the (n+1)th inference knowledge generated by the (n+1)th inference does not have contradiction with the existing knowledge in the original knowledge base, then the inference can be continued on the basis of the (n+1)th inference knowledge.

If the (n+1)th inference knowledge generated by the (n+1)th inference has contradiction with the existing knowledge in the original knowledge base and wrong knowledge or a knowledge with a lower accuracy in the knowledges having contradiction is the knowledge in the (n+1)th inference knowledge, then interruption of an inference process is caused, that is, the inference can no longer be continued on the basis of the (n+1)th inference knowledge.

In one embodiment, when any knowledge belonging to the (n+1)th inference knowledge has contradiction with the existing knowledge in the original knowledge base and any knowledge belonging to the (n+1)th inference knowledge is wrong knowledge or a knowledge with a lower accuracy in the knowledges having contradiction, interruption of an inference process is caused. Any knowledge belonging to the (n+1)th inference knowledge includes inference knowledge on any branch when a branch structure occurs in the (n+1)th inference; or any knowledge in a group of knowledge when no branch structure occurs in the (n+1)th inference, the inference knowledge being the group of knowledge. By this method, when the knowledge having contradiction with the existing knowledge in the original knowledge base occurs in the inference knowledge, and wrong knowledge or a knowledge with a lower accuracy in the knowledges having contradiction is the knowledge in the inference knowledge, the inference process can be interrupted, so as to prevent a situation that more errors are caused due to the fact that the inference is continued on the basis of the inference knowledge that may have errors.

Optionally, in other embodiments, when it is described that “if the generated (n+1)th inference knowledge has contradiction with the existing knowledge in the original knowledge base, and wrong knowledge or a knowledge with a lower accuracy in the knowledges having contradiction is the knowledge in the (n+1)th inference, interruption of an inference process is caused”, it is also possible that only the knowledges having contradiction with the existing knowledge in the original knowledge base will cause the interruption of the inference process, and other knowledge that does not have contradiction with the existing knowledge in the original knowledge base can allow the inference to be continued.

S44, forming an inference loop if inference is performed on the basis of the inference chain and the obtained inference knowledge already exists in the inference chain.

In one embodiment, whenever new knowledge not existing in the original knowledge base is inputted into the knowledge base, inference is started based on the new knowledge not existing in the original knowledge base; if the generated (n+1)th inference knowledge has contradiction with the existing knowledge in the original knowledge base, and wrong knowledge or a knowledge with a lower accuracy in the knowledges having contradiction is knowledge in the (n+1)th inference knowledge, interruption of an inference process is caused; at this time, the inference loop cannot be formed due to the interruption of the inference process, and at this time, the newly inputted new knowledge not existing in the original knowledge base and the inference knowledge obtained based on the newly inputted new knowledge not existing in the original knowledge base are processed.

Optionally, processing the newly inputted new knowledge not existing in the original knowledge base and the inference knowledge obtained based on the newly inputted new knowledge not existing in the original knowledge base includes: reporting an error to an external supervisor of the system and requesting the external supervisor of the system to process the newly inputted new knowledge not existing in the original knowledge base and the inference knowledge obtained based on the newly inputted new knowledge not existing in the original knowledge base; or directly excluding the newly inputted new knowledge not existing in the original knowledge base and the inference knowledge obtained based on the newly inputted new knowledge not existing in the original knowledge base from the knowledge base.

Optionally, processing by the external supervisor of the system may include: if the external supervisor considers the newly inputted new knowledge not existing in the original knowledge base and the inference knowledge obtained based on the newly inputted new knowledge not existing in the original knowledge base as correct knowledge, intervening in the above knowledge, for example: marking the above knowledge as correct knowledge and checking the knowledges having contradiction therewith; if the external supervisor considers the above knowledge as wrong knowledge, excluding the above knowledge from the knowledge base, for example, deleting it from the knowledge base.

In this embodiment, processing the newly inputted new knowledge not existing in the original knowledge base and the inference knowledge obtained based on the newly inputted new knowledge not existing in the original knowledge base includes: reporting an error to the external supervisor of the system and requesting the external supervisor of the system to process the above knowledge.

In this embodiment, every time new knowledge not existing in the original knowledge base is inputted, a group of new knowledges not existing in the original knowledge base is inputted into the knowledge base, in the inference process, in case of interruption of the inference, if it is considered that the newly inputted new knowledge not existing in the original knowledge base and the inference knowledge based on the newly inputted new knowledge not existing in the original knowledge base are wrong knowledge or a knowledge with a lower accuracy, the newly inputted group of new knowledges not existing in the original knowledge base and the inference knowledge obtained based on the newly inputted group of new knowledge not existing in the original knowledge base are excluded from the knowledge base.

Optionally, if there is an enlightenment knowledge base in which the amount of knowledges exceeds a preset knowledge quantity threshold and the accuracy of knowledges also exceeds a preset knowledge accuracy threshold, a first inference loop can be constructed based on the enlightenment knowledge base. Due to the existence of the enlightenment knowledge base, it can be considered that the existing knowledge in the original knowledge base is correct knowledge or a knowledge with a higher accuracy.

Optionally, if no interruption of inference occurs after a preset time, new knowledge not existing in the original knowledge base is inputted to the knowledge base to start new inference and continuous inference.

It can be appreciated that the inference loop is a dynamic structure and is in a process of dynamic change; and in the process of dynamic change, the loop structure of the inference loop may become larger, may become smaller, may remain unchanged for a certain duration, or may be destroyed and returned to a chain structure. The dynamic change of the inference loop depends on the interference of knowledge outside the inference loop on the inference loop. The knowledge outside the inference loop may include newly inputted knowledge not existing in the knowledge base, existing knowledge that already exists in the knowledge base but has never interacted with the inference loop, and new inference knowledge obtained through inference that has not interacted with the inference loop.

The interference of the knowledge outside the inference loop on the inference loop includes the following types.
(1) If the knowledge outside the inference loop does not have knowledge that can interfere with the inference loop, the inference loop is in a stable state. At this time, in a connection path of the inference loop, the inference engine repeatedly performs inference in an infinite loop manner, and in the process of repeatedly performing the inference in an infinite loop manner, in addition to obtaining the existing knowledge on the inference loop continuously, it is also possible to obtain an inference knowledge not existing on the inference loop, thus extending an inference chain from the inference loop.
(2) If there is first knowledge existing in the knowledge outside the inference loop, the first knowledge may be integrated into the inference loop to form one new inference loop including the existing knowledge in the original inference loop and the first knowledge, and at this time, the inference loop becomes larger.
(3) The original inference loop includes a first pat of knowledge and a second part of knowledge, and if there is second knowledge in the knowledge outside the inference loop, the second knowledge may form one new inference loop with the first part of knowledge in the inference loop. At this time, a state change of the inference loop is pending, which needs to be analyzed according to specific situations, and the original inference loop can still exist or not. The specific situations may include: the new inference loop just has a shorter path than the original inference loop, and has no contradiction with the original inference loop; or the second knowledge has contradiction with the second part of knowledge, and results in that the second part of knowledge is excluded from the knowledge base.
(4) If the knowledge outside the inference loop has fourth knowledge, the inference loop may be disconnected by the fourth knowledge, and at this time, the loop structure of the inference loop is destroyed and returned to the inference chain structure. For example, if wrong knowledge exists on the inference loop and the wrong knowledge has contradiction with the correct knowledge, the wrong knowledge is excluded from the knowledge base, resulting in that the loop structure of the inference loop is destroyed.

S45, setting node states and state values.

Nodes can include inference nodes, knowledge graphs, probability graphs, knowledge nodes and probability nodes in the inference chain or the inference loop. In this embodiment, the node state and the state value are set for each inference node. In other embodiments, it is also possible to set the node states and the state values for each knowledge node and each probability node, or set the node states and state values for each knowledge graph and each probability graph.

The node state is used to characterize whether the node is used, including an activated state and a nonactivated state. The use of a node includes that the node is invoked to participate in a matching task, the node is invoked to participate in an inference task, and the node is invoked to participate in a checking task and other tasks. If the node is used, the node will be activated. The activation of the node includes that the node in a nonactivated state is switched to an activated state, and the node in an activated state is activated again to maintain or update the activated state. If the node is in the activated state and the node is not activated again after a first preset duration, the node state is switched from the activated state to the nonactivated state.

A node state value is used to characterize the usage of a node.

Every time the node is activated, the state value of the node is increased by a first preset value. Therefore, the more times a node is activated, the greater the state value of the node is, and the greater the state value of the node is, the more times the node is used. As a result, when there are scenes that need to use the node, such as the matching task, the inference task and the checking task, the possibility of invoking the node with a larger state value to complete the task is higher.

Optionally, the usage of the node also includes taking a use result of the node into consideration, for example, taking the contribution to the completion of the task as a consideration factor of the usage of the node, and if the node participating in the task contributes to the completion of the task, the state value of the node is to be additionally increased by a second preset value. If the node participating in the task does not contribute to the completion of the task, the state value of the node is to be reduced by a third preset value or remains unchanged. Through the above method, the state value of the node can be encouraged or punished according to the use result of the node.

Further, the state value of the node decreases by a fourth preset value every time second preset duration elapses, the state value of the node. The state values of the nodes can be reduced cumulatively until the state values of the nodes are reduced to a preset minimum value that cannot be reduced.

Through the above method, the state value of the node can be adjusted according to the usage of the node; then, the node is classified and managed according to the state value of the node. For example, a use priority of the node is set, the greater the node state value is, the higher the corresponding use priority of the node is. In this way, in the case that the knowledge base includes enough knowledge, the knowledge in the knowledge base can be reasonably used according to the usage of knowledge. The utilization efficiency and the use efficiency of the knowledge in the knowledge base are improved.

It can be appreciated that the greater the node state value is, the higher the corresponding use priority of the node is; the higher the use priority is, the more times the node is used; the more times the node is used, the greater the node state value is, thereby forming a positive feedback cycle. Further, the state value of the node can be encouraged or punished according to the use result of the node, so as to adjust a feedback situation.

It can be appreciated that a process that the state value of the node is increased can be regarded as a process of simulating the human brain to use and memorize knowledge; and a process that the state value of the node is reduced with time can be regarded as a process of simulating the forgetting of the knowledge memorized by the human brain with time.

It can be appreciated that by setting the state value of the node, it can also be considered that the knowledge corresponding to the node may have activity, and the increase of the node state value is equivalent to the increase of the knowledge activity corresponding to the node, and the decrease of the node state value is equivalent to the decrease of the knowledge activity corresponding to the node. If the node state value remains unchanged in a certain way, the knowledge corresponding to the node keeps certain activity. When the node state value decreases the preset minimum value, it is equivalent to the loss of the knowledge activity corresponding to the node, and it can be considered that the knowledge is forgotten or the knowledge is idle and only stored in the knowledge base.

Optionally, when the node is activated, an activated state propagates from the node in the activated state to other nodes on the connection path along the connection path of the nodes, so that the other nodes are activated, thereby increasing the overall state value of the node connection path. Preferably, an activated state of the node propagates in one direction. If the node is an inference node, a propagation direction of the activated state of the inference node is the inference direction.

S46, forming an inference cycle based on an inference loop, node states and state values.

After the inference loop is formed, if there is no other knowledge that can destroy the loop structure of the inference loop, then the inference engine performs infinite loop inference on the connection path of the inference loop and continuous inference to obtain the existing knowledge on the inference loop, and the inference nodes on the inference loop are to be activated periodically, forming a dynamic cycle of the activated states of the inference nodes on the inference loop, thereby forming an inference cycle capable of increasing the state values of the inference nodes on the connection path of the inference loop. Compared with the knowledge not forming the inference loop, the inference nodes on the inference loop have higher state values because of the existence of the inference cycle, and the activated state can propagate along the node connection path, so that the inference chain having a connection relation with the inference loop also has a higher state value.

In addition, the state value of the node decreases by the fourth preset value every time the second preset duration elapses. Therefore, by adjusting an increment and a decrement of the node state value in various situations, the state value of the inference loop can remain unchanged, or increase or decrease steadily only under the action of the inference cycle.

In one embodiment, if the state value of the inference loop remains unchanged only under the action of the inference cycle, then, under the same circumstances, the state value of the inference chain connected with the inference loop steadily attenuates to the preset minimum value, and after the state value of the inference chain connected with the inference loop decreases to the preset minimum value, the state value of the inference chain connected with the inference loop increases periodically due to the inference cycle and the propagation of the activated state; in addition, under the same circumstances, the state value of the inference chain not connected with the inference loop steadily attenuates to the preset minimum value, and a gradient (slope) of a steady decline of the state value of the inference chain not connected with the inference loop is greater than that of a steady decline of the inference chain connected with the inference loop.

Through the self-learning method based on the universal self-learning system, the inference loop and an inference cycle about knowledge can be constructed in the knowledge base, and the self-consistency and activity of the knowledges in the knowledge base can be maintained through the dynamic and sustainable inference cycle with high activity. The knowledges in the knowledge base includes the existing knowledge in the knowledge base and the newly inputted knowledge not existing in the knowledge base originally.

Several inference cycles constitute subject knowledge in the knowledge base. If the newly inputted new knowledge not existing in the original knowledge base has contradiction with the subject knowledge, or the (n+1)th inference knowledge generated by continuous inference started based on the newly inputted new knowledge not existing in the original knowledge base has contradiction with the subject knowledge, the interruption of the inference is caused to affect the inference cycle, so that the wrong knowledge in the knowledges having contradiction is discovered and excluded from the knowledge base. In this way, the self-consistency of the knowledge in the knowledge base can be realized. It can be appreciated that causing the interruption of the inference to affect the inference cycle includes a situation that the interruption of the inference is caused when the newly inputted knowledge not existing in the original knowledge base, or the (n+1)th inference knowledge generated by continuous inference based on the newly inputted new knowledge not existing in the original knowledge base is wrong knowledge or a knowledge with a lower accuracy, so that no inference cycle can be formed; in a few situations, when the knowledge in the original inference cycle is wrong knowledge or a knowledge with a lower accuracy, the original inference cycle cannot be continued or a new inference cycle can be formed.

By constructing the inference cycle and constantly checking the knowledge through the inference cycle, the knowledges having contradiction with the subject knowledge of the knowledge base can be continuously verified and searched, so as to implement the self-consistency of the knowledge in the knowledge base, but it can be appreciated that the knowledge base may not necessarily be completely self-consistent at any time. In a process of verifying and searching for knowledges having contradiction with the subject knowledge of the knowledge base through the inference cycle, there may still be the knowledge in the knowledge base that affects the self-consistency of the knowledge base.

In this embodiment, the self-consistent inference cycle may have a universal ability to judge whether the new knowledge is correct or wrong, and the universal ability to judge whether the knowledge is correct or wrong can be regarded as consciousness, thus the self-consistent inference cycle can be regarded as a machine consciousness, and through the self-consistent inference cycle, a world view of the universal self-learning system is formed in a sense, which may even be called an artificial consciousness body. Therefore, it can be considered that the universal self-learning system may gradually have a machine consciousness in a process of use.

Based on several self-consistent inference cycles, independent learning of the universal self-learning system in any field can also be implemented, the technical problems in multiple technical fields can be solved, and the manual assistance cost of learning knowledge by the universal self-learning system is greatly reduced.

Further, a connection structure of the knowledge of the present disclosure is highly similar to a neuron structure, and the nodes can be compared to neurons, the node relations can be compared to neurites of neurons, and a network structure indicating knowledge is similar to a neuron connection structure in the human brain; the nodes are activated when used, and the generation of the activated state and the conduction characteristic of the activated state are similar to functions of receiving stimuli and generating and conducting excitement by neurons, wherein the conduction characteristic of the activated state can be similar to bioelectricity, and the nodes compared to the neurons can be regarded as memory nodes of the knowledge.

A process in which the state value of the node is increased when the node is activated can be considered as a process of simulating the human brain to use and memorize knowledge; the more the knowledge is used, the deeper the memory is; the greater the state value of the knowledge is, the higher the priority of use is, which also corresponds to an idea of giving priority to applying common knowledge and habitual thinking to solve problems in the human brain; and a process that the state value of the node is reduced with time can be regarded as a process of simulating the forgetting of the knowledge memorized by the human brain.

After the inference loop is formed, the knowledge in the present disclosure may maintain the knowledge activity under the action of the inference cycle, which can be regarded as an active neuron area for the human brain to memorize common knowledge.

The connection method of connecting the two knowledges described in S22 is equivalent to a process of deepening the understanding of knowledge after repeated learning, and sorting scattered and fragmented knowledge into structured and systematic knowledge; inevitable inference with 100% connection probability in the probability rules is similar to deductive inference in the human brain, and probabilistic inference with less than 100% connection probability in the probability rules is similar to guess or imagination in the human brain; and a process of checking by the judging machine is a process of constantly identifying and verifying the authenticity of knowledge.

The universal self-learning system of the present disclosure has functions of learning, memorizing, understanding, inference, guess, imagination and checking, and the knowledge stored therein has activity.

An embodiment of the present disclosure provides an electronic device, including a processor and a memory.

The memory can be configured to store the knowledge in the knowledge base and store computer programs, including execution programs of the inference engine and judging machine.

In one embodiment of the present disclosure, the processor, when being configured to execute the program stored in the memory, implements the method provided in any of the above method embodiments.

Optionally, the processor above may be a general central processing unit (CPU), a network processor (NP), a microprocessor, an application-specific integrated circuit (ASIC), or one or more integrated circuits for controlling the execution of the program in a solution of the present application.

The memory can be a read-only memory (ROM) or other types of static storage devices that can store static information and instructions, a random access memory (RAM) or other types of dynamic storage devices that can store information and instructions, and can also be an electrically erasable programmable read-only memory (EEPROM), a compact disc read-only memory (CD-ROM) or other optical disk storage, an optical disk storage (including a compact disk, a laser disk, an optical disk, a digital versatile disk, a Blu-ray disks, etc.), a magnetic disk storage medium or other magnetic storage devices, or any other medium that can be used to carry or store desired program codes in the form of instructions or data structures and can be accessed by a computer, but is not limited thereto. The memory may exist independently and be connected with the processor through a bus. The memory may also be integrated with the processor.

An embodiment of the present disclosure also provides a computer-readable storage medium having stored thereon a computer program, the computer program, when executed by a processor, implementing the steps of the method provided by any of the above method embodiments.

Those of skill would further appreciate that units and algorithm steps of various examples described in connection with the embodiments disclosed herein may be implemented as electronic hardware, computer software, or a combination of both, and that the components and steps of the various examples have been described above generally in terms of their functionality in order to clearly illustrate this interchangeability of the hardware and software. Whether these functions are implemented in hardware or software depends on the specific application and design constraints of the technical solution. The skilled person can use different methods to implement the described functions for each particular application, but this implementation should not be considered beyond the scope of the present disclosure.

The steps of a method or an algorithm described in connection with the embodiments disclosed herein may be implemented in hardware, a software module executed by a processor, or a combination of both. The software module may be placed in a random access memory (RAM), an internal memory, a read-only memory (ROM), an electrically programmable ROM, an electrically erasable programmable ROM, a register, a hard disk, a removable disk, CD-ROM, or any other form of storage medium known in the art.

The above are merely specific embodiments of the present disclosure, so that those skilled in the art can understand or implement the present disclosure. Many modifications to these embodiments will be obvious to those skilled in the art, and the general principles defined herein can be implemented in other embodiments without departing from the spirit or scope of the present disclosure. Therefore, the present disclosure is not to be limited to these embodiments shown herein, but is to conform with the widest scope consistent with the principles and novel features of the present disclosure herein.

What is claimed is:

1. A self-learning method based on a universal self-learning system, the universal self-learning system comprising a knowledge base and an inference engine, the knowledge base comprising several knowledges, the inference engine generating an inference knowledge through inference on the basis of the knowledge in the knowledge base, the self-learning method comprising the following steps:
performing inference on the basis of the knowledge in the knowledge base to generate the inference knowledge;
performing inference on the basis of acquired nth inference knowledge to obtain (n+1)th inference knowledge, and performing several rounds of inference continuously to form an inference chain; and
forming an inference loop under the condition that the knowledge inferred according to the inference chain already exists in the inference chain.

2. The self-learning method based on the universal self-learning system according to claim 1, the universal self-learning system further comprising a judging machine, the judging machine being configured to check the knowledges in the knowledge base and to find and process the knowledges having contradiction, the self-learning method comprising the following steps:
checking a generated (n+1)th inference knowledge based on the existing knowledge in the knowledge base;
under the condition that the (n+1)th inference knowledge does not have contradiction with the existing knowledge in an original knowledge base, continuing the inference on the basis of the (n+1)th inference knowledge; and
under the condition that the (n+1)th inference knowledge has contradiction with the existing knowledge in the original knowledge base and wrong knowledge or a knowledge with a lower accuracy in the knowledges having contradiction is the knowledge in the (n+1)th inference knowledge, causing interruption of an inference process.

3. The self-learning method based on the universal self-learning system according to claim 2, the self-learning method comprising the following steps:
under the condition that new knowledge not existing in the original knowledge base is inputted into the original knowledge base, starting the inference based on the new knowledge not existing in the original knowledge base and the knowledge in the original knowledge base, and performing the inference on the basis of the newly inputted new knowledge not existing in the original knowledge base, to obtain an inference knowledge based on the newly inputted new knowledge not existing in the original knowledge base;
under the condition that interruption of the inference does not occur after a preset time, inputting new knowledge not existing in the knowledge base to the knowledge base to start new inference and continuous inference; and
under the condition that interruption of the inference process occurs, excluding the newly inputted new knowledge not existing in the original knowledge base and additionally inputting new knowledge not existing in the original knowledge base to perform inference.

4. The self-learning method based on the universal self-learning system according to claim 2, wherein,
the inference loop is a dynamic structure;
under the condition that the knowledge outside the inference loop does not interfere with the inference loop, the inference loop is in a stable state;
under the condition that the knowledge outside the inference loop is capable of being integrated into the inference loop, a new inference loop comprising the existing knowledge in the original inference loop and newly integrated knowledge is formed, and the inference loop becomes larger;
under the condition that the knowledge outside the inference loop and some knowledge in the original inference loop form a new inference loop, a state change of the inference loop is pending; and
under the condition that the knowledge outside the inference loop allows the inference loop to be unable to continue to connect, the inference loop changes from a loop structure to an inference chain structure.

5. The self-learning method based on the universal self-learning system according to claim 1, wherein,
the inference loop comprises several nodes, and the nodes have connection relations to form the loop structure and are capable of being activated; and
when the inference engine performs circular inference on a connection path of the inference loop, the nodes on the inference loop are activated periodically, and a dynamic cycle in which the nodes on the inference loop are activated constitutes an inference cycle.

6. The self-learning method based on the universal self-learning system according to claim 5, wherein,
the nodes have state values, node state value change situations and node state value change values corresponding to the node state value change situations are preset, the preset node state value change situations comprising:
every time the nodes are activated, the state values of the nodes increase;
every time after a preset duration is elapsed, the state values of the nodes decrease; and
the state values of the nodes are capable of being reduced cumulatively until a preset minimum value is reached.

7. The self-learning method based on the universal self-learning system according to claim 6, wherein,
under the action of the inference cycle, a state value of the inference loop has one of three numerical states, namely, a stable unchanging state, a stable increasing state and a stable decreasing state.

8. The self-learning method based on the universal self-learning system according to claim 6, wherein,
an incidence relation exists between the node state value and a node use priority, and the greater the node state value is, the higher the node use priority is.

9. The self-learning method based on the universal self-learning system according to claim 5, wherein,
when the node is activated, an activated state propagates from the node in the activated state to other nodes on the connection path along the connection path of the nodes, so that the other nodes are activated.

10. The self-learning method based on the universal self-learning system according to claim 1, wherein,
the inference engine is generated based on the knowledge in the knowledge base.

11. The self-learning method based on the universal self-learning system according to 10, wherein construction of the inference engine comprises the following steps:
summarizing knowledge generation probability rules in the knowledge base; and
based on the probability rules, performing inference on the basis of the knowledge in the knowledge base to generate the inference knowledge.

12. The self-learning method based on the universal self-learning system according to 2, wherein the construction of the judging machine comprises the following steps:
checking a knowledge to be checked based on the existing knowledge in the knowledge base, and judging a relation between the knowledge to be checked and the existing knowledge in the original knowledge base;
under the condition that the existing knowledge having contradiction with the knowledge to be checked is found, checking correctness of the knowledge to be checked and the existing knowledge having contradiction with the knowledge to be checked; and
based on a checking result, excluding wrong knowledge or a knowledge with a lower accuracy from the knowledge base.
